(19) United States
(12) Patent Application Publication
(10) Pub. No.: US 2009/0252843 A1
(43) Pub. Date: Oct. 8, 2009

(54) HIGH FIBER FLOUR-BASED SYSTEM

(75) Inventor: David C. Skinner, Valle Crucis, NC (US)

Correspondence Address: HOFFMANN & BARON, LLP, 6900 JERICHO TURNPIKE, SYOSSET, NY, 11791, US

(73) Assignee: AMISH NATURALS, INC., Holmesville, OH (US)

(21) Appl. No.: 12/417,059

(22) Filed: Apr. 2, 2009

Related U.S. Application Data
(60) Provisional application No. 61/041,747, filed on Apr. 2, 2008.

(51) Int. Cl. A21D 10/00; A23P 1/02

(52) U.S. Cl. 426/272; 426/555

(57) ABSTRACT

A method of preparing an all natural high fiber flour-based concentrate is provided. The method includes dry functionalizing a flour-based host/carrier to extract endogenous moisture, dry combining a low-moisture-content fiber source (LMFS) into the flour-based host/carrier in an amount which provides a substantially homogenous mixture throughout the flour-based host/carrier, and dry blending into the homogeneous mixture at least one grain-based binder having a moisture content greater than the LMFS.

### CROSS REFERENCE TO RELATED APPLICATIONS

The present application claims priority to U.S. Provisional Application No. 61/041,747 filed on Apr. 2, 2008, the entirety of which is incorporated herein by reference.

### BACKGROUND OF THE INVENTION

The present invention relates to flour-based comestibles, and in particular, to a method and composition for increasing the fiber content of such comestibles.

The USDA recommends that Americans eat a diet high in fiber and low in fat. The benefits of a high fiber diet are numerous and include reduced risk of heart disease and stroke, reduced risk of large bowel cancer, reduction in cholesterol, a moderation of blood sugar levels, and aid in weight loss.

According to the USDA, the Institute of Medicine recommends 19-38 grams of fiber per day, depending on age and gender, with at least three daily servings of whole-grain foods. However, according to the USDA, the average American consumes only 14 grams of dietary fiber per day. Thus, there is a need for foods that have a higher fiber content, to permit people to increase their fiber intake.

In view of the foregoing, an increasing number of high fiber foods and supplements are being created. However, the flour based food products conventionally prepared that have the desired nutritional criteria do not include a satisfactory amount of fiber. Naturally made white flour contains only a relatively small amount of fiber, e.g., about 0.1-1%.

In an effort to increase fiber content, attempts have been made to blend fiber into the flour of flour based products. Many high fiber blends restrict volume and do not provide proper absorption. This can give flour-based comestibles, such as bread, a “heavy” or “dense” texture and taste. In addition, many of the high fiber flour based blends currently available have an unpleasant taste caused by the fiber supplements.

Thus, there remains a need to increase the fiber content of flour-based comestibles without incurring the unwanted organoleptic shortcomings normally associated with increasing fiber in flour-based foods.

### SUMMARY OF THE INVENTION

A method of preparing an all natural high fiber flour-based concentrate is provided. An article of manufacture is also provided that includes an all natural high fiber flour-based concentrate manufactured by the steps of the method of the invention. A comestible is also provided that includes the high fiber flour-based concentrate.

The method includes the steps: a) dry functionalizing a flour-based host/carrier to exude endogenous moisture; b) semi-sequentially dry combining (SSDC) a low-moisture-content fiber source (LMFS) with the flour-based host/carrier in an amount which provides a substantially homogenous mixture throughout the flour-based host/carrier; and, c) dry blending at least one grain-based binder into the homogeneous mixture to form a substantially dry high fiber flour-based concentrate, the grain-based binder having a moisture content greater than that of the LMFS.

In a preferred embodiment, a grain-based texturizer is added during the step of dry blending the grain-based binder. A preferred grain-based texturizer is wheat starch, preferably modified wheat starch. Preferably, the grain-based texturizer has a moisture content that is greater than that of the LMFS and the grain-based binder, but less than that of the flour-based host/carrier.

In another preferred embodiment, the method further includes an additional step d) of subjecting the substantially dry mixture resulting from steps a) through c) to sifting to regularize particles size of the dry mixture. In another preferred embodiment, the method further includes a step e) of agglomerizing the sifted dry concentrate resulting from step d) based on the binding characteristic of the moisture exudate of the dry ingredients to provide particle aggregates of substantially uniform size and flow characteristics.

Various flavors can be added to the dry mixture flour-based concentrate. Preferably the flavors are added during the sifting step.

In a preferred embodiment, the flour-based host/carrier is a wheat-based flour having a moisture content of from about 10% to about 15%. The wheat based flour can be, for example, durum wheat having a moisture content of from about 12% to about 15% or whole wheat having moisture content of from about 10% to about 13%.

In a preferred embodiment, the LMFS is a vegetable fiber having a moisture content of less than about 6% and a dietary fiber content of greater than about 80%. The LMFS can be any edible high fiber ingredient. Preferably, the vegetable fiber is one that includes inulin, such as Jerusalem artichoke.

The LMFS can be added in any amount suitable to give the desired fiber characteristics. For example, the LMFS can be added in an amount of about 4 wt % to about 16 wt % of the concentrate.

The at least one grain-based binder can be selected, for example, from the group consisting of wheat protein, wheat gluten, and a combination thereof. The grain-based binder can include, for example, wheat protein and/or wheat gluten added in an amount of from about 3 wt % to about 12 wt % of the flour-based concentrate.

One embodiment contemplates that the at least one grain-based binder include wheat protein or wheat gluten added in an amount of from about 3 wt % to about 12 wt % of the concentrate, and a grain-based texturizer that includes wheat starch added in an amount of from about 20 wt % to about 50 wt % of the concentrate.

In another aspect of the invention, an article of manufacture is provided. The article of manufacture includes an all natural high fiber flour-based concentrate, manufactured by the steps of the method described herein.

In another aspect of the invention, a method of preparing an all natural high fiber flour-based comestible is provided. The method includes steps a) through c) as stated above. In a preferred embodiment the method further includes the step of mixing the high fiber flour-based concentrate resulting from steps a) through c) with suitable wheat-flour and a liquid to form a dough which can be processed into a desired comestible end product.

In another embodiment, a comestible is provided that includes the all natural high fiber flour-based concentrate.

The methods and comestibles produced using the methods of the invention satisfy the need to increase the fiber content of flour-based comestibles without incurring the unwanted organoleptic shortcomings normally associated with increasing fiber in flour-based foods. As discussed above, high fiber foods, especially flour-based foods such as bread, traditionally have a heavy feel and are often grainy. The bread made using the high fiber flour-based concentrate of the invention has a natural lightness and good mouth feel, without the traditional heaviness of high fiber breads.

In addition, the inventors have discovered that the addition of flavors, especially seasonings such as garlic, etc., during sifting enhances the intensity and sustains the potency of the seasoning.

### DETAILED DESCRIPTION OF THE INVENTION

The present invention provides a method of preparing an all natural high fiber flour-based concentrate. The invention also includes the flour-based concentrate itself and high fiber products produced with the flour-based concentrate.

“All natural” as defined herein means that only products from nature or derived from nature are used in the methods and products of the invention. Examples include wheat and wheat-based ingredients, such as wheat flour, wheat gluten, wheat protein and wheat starch. Additional examples include vegetable fiber and natural flavorings. Synthetic ingredients or those that are chemically manufactured are preferably not employed.

“Flour” as defined herein means the glutinous and/or starchy powder obtained from the milling of grains or other vegetable matter, as described above. Grain, i.e., the grass fruit, includes the endosperm, which is the starchy part; the germ, which is the proteinaceous part; and the bran or fiber part. Different types of flour include different percentages of starch and protein.

“High fiber” means having a higher dietary fiber content than is conventionally found in wheat flour. Conventional whole wheat flour may have a dietary fiber content of at most about 10 grams per 100 gram serving. The high fiber flour-based concentrate of the invention can have, for example, a dietary fiber content of between 30 to 100 grams per 100 gram serving. Preferably, the high fiber flour-based concentrate has between 70-80 grams of dietary fiber per 100 gram serving.

The method includes dry functionalizing (DF) a flour-based host/carrier to exude endogenous moisture, dry combining a low-moisture-content fiber source (LMFS) into the flour-based host/carrier in an amount which provides a substantially homogenous mixture throughout the flour-based host/carrier, and dry blending into the homogeneous mixture at least one grain-based binder having a moisture content greater than the LMFS.

“Dry functionalizing” as defined herein means disrupting the structure of a flour-based host/carrier, e.g., by mechanical mixing, sufficient to free the moisture in the flour-based host/carrier so that the endogenous moisture exudes and acts as a mixing aid, e.g., surfactant. Dry functionalizing in the invention process means that no added water is used to affect hydration sufficient to provide a homogenous mixture between a flour-based host/carrier and a low-moisture fiber source.

A “flour-based host/carrier” as defined herein is a major component of the comestible which serves as a matrix, mixing-enhancer, diluent, and compatibilizer when the flour-based concentrate is used as a component to increase fiber content in flour-based goods. For example, the flour-based host/carrier can be any type of flour made from grain as long as it possesses the ability to affect homogenous mixing in the absence of added water when dry functionalized. For example, the flour-based host/carrier can include wheat flour, rice flour, corn flour, etc., assuming it has the requisite endogenous moisture content.

The flour-based host/carrier must be capable of endogenous moisture exudation upon disruption of its structure, e.g., by mechanical mixing. Furthermore, the flour-based host/carrier must have a moisture content sufficient to hydrate itself and at least a fiber component, in order to provide a substantially homogenous mixture.

The flour-based host/carrier should have an endogenous moisture content of at least about 10% to about 16%. In preferred embodiments, the host carrier is durum wheat or whole wheat. In the case of durum wheat, the moisture content is preferably from about 12% to about 15%. In the case of whole wheat, the moisture content is preferably about 10% to about 13%. In the case of modified wheat starch, the moisture content is preferably about 8% to about 13%.

Methods of determining the moisture content of grain-based components, such as flour, are known in the art. As defined herein, percent moisture content is determined using the method as set forth by the International Association for Cereal Science and Technology (ICC), Standard No. 110/1. In general, the method includes a determination of the weight loss by a sample when dried under fixed conditions.

Whole wheat flour is a powdery substance derived from grinding or mashing the whole grain of the wheat. The word “whole” refers to the fact that all of the wheat grain, i.e., the bran, germ and endosperm, are ground without removing any portion of the grain in the process of making the flour. The presence of the bran and germ give whole wheat flour its brown appearance. This is in contrast to “white” or processed flour which contain only the endosperm.

A “low-moisture-content fiber source” (LMFS) means a high fiber ingredient which has a low moisture content. The LMFS can include any vegetable fiber having a moisture content less than about 6% and a dietary fiber of greater than 80%.

Dietary fiber is the indigestible portion of plant foods that moves through the digestive system, absorbs water, and facilitates defecation. Dietary fiber consists of non-starch polysaccharides. Examples of such polysaccharides includes inulin, cellulose, dextrins lignin, waxes chitins, pectins, beta-glucans and oligosaccharides.

In a preferred embodiment, the LMFS is a vegetable fiber that includes inulin. Inulin is a group of oligosaccharides occurring naturally in many plants. They belong to a class of carbohydrates known as fructans. Plants that include high concentrations of inulin include elecampane, dandelion, wild yam, Jerusalem artichoke, chickory, jicama, burdock, onion, garlic, agave, and yacon. In a preferred embodiment, the inulin is derived from Jerusalem artichoke.

Inulin has unique nutritional characteristics. It ranges from completely bland to subtly sweet and can be used to replace sugar and fat. This is particularly advantageous because inulin contains a third to a quarter of the food energy of sugar or other carbohydrates and a sixth to a ninth of the food energy of fat. Inulin has a minimal impact on blood sugar levels and, in contrast to fructose, is not insulemic and does not raise triglyceride levels. These characteristics make inulin suitable for diabetics and potentially helpful in managing blood sugar-related illnesses.

Commercial sources of inulin are also available. For example, Cargill, Inc. sells Oliggo-Fiber® Inulin, which is a naturally occurring fructan extracted from chickory root. Inulin derived from Jerusalem artichoke is available from Meelunie American Inc., Farmington Hills, Mich.

Inulin is generally accepted as a soluble dietary fiber as defined the American Association of Cereal Chemists (AACC) and the Food and Nutrition Board, Institute of Medicine.

In a preferred embodiment, the LMFS is Jerusalem artichoke having a moisture content of about 5% and a dietary fiber (inulin) content of between about 85-95%, preferably at least about 85%.

“Semi-sequentially dry combining” (SSDC) means adding the LMFS to the flour-based host/carrier in the absence of added water. SSDC further means that the LMFS is added to the flour-based host/carrier simultaneously with onset of functionalization or after functionalization, i.e., exudation of endogenous moisture from the flour-based host/carrier, has begun. In a preferred embodiment, SSDC of the LMFS with the flour-based host/carrier occurs after functionalization of the flour-based host/carrier has been started.

The SSDC step includes adding the LMFS in an amount such that a substantially homogenous mixture is achieved between the LMFS and the flour-based host/carrier. The amount of LMFS added in relation to the flour-based concentrate is approximately between 4 wt % and 16 wt % of the flour-based concentrate, preferably between 5 wt % and 12 wt % of the concentrate, more preferably between 6 wt % and 10 wt % of the flour-based concentrate. In a preferred embodiment, the LMFS is inulin derived from Jerusalem artichoke and added in an amount of about 7.5 wt % of the flour-based concentrate.

The method of the invention further includes dry blending at least one grain-based binder into the homogeneous mixture formed by the flour-based host/carrier and LMFS. “Dry-blending” as defined herein means further mixing at least one, and preferably more than one, grain-based binder in the absence of added water. The grain-based binder has a moisture content greater than that of the LMFS. In addition, the grain-based binder preferably has a moisture content less than that of the host/carrier. “Grain-based” as used herein means that the component is derived from the grain, i.e., the grass fruit. In a preferred embodiment, the at least one grain-based binder is selected from the group consisting of wheat protein, wheat gluten, or a combination thereof.

The term “wheat protein” as used herein generally refers to wheat protein isolates derived from wheat gluten. Wheat protein isolates are generally separated from wheat gluten by taking advantage of wheat gluten's solubility at alkaline or acidic pH values. The wheat gluten exhibits a classical “U-shaped” solubility curve with a minimum solubility, or isoelectric point, at pH 6.5-7.0. The gluten can be solubilized, and the wheat proteins can be separated from non-protein components by processes like filtration, centrifugation, or membrane processing followed by spray drying. Alternatively, wheat protein can be obtained by wet processing of wheat flour. The wheat flour can be repeatedly kneaded, water washed, and dewatered to remove contaminating starch and other non-protein components, and subsequently flash dried. These techniques yield a wheat protein isolate product with elevated protein content, at least about 85% by weight, more preferably at least about 90% by weight (on an N×6.25, dry basis, where N is the total nitrogen in the dried wheat flour). Wheat protein isolates are less elastic but more extensible than wheat gluten. Examples of preferred wheat protein isolates include ARISE 3000, ARISE 5000, and ARISE 6000 available from MGP Ingredients, Inc., Atchison, Kans.

As used herein, “wheat gluten” is a binary mixture of the glycoproteins gliadin and glutenin derived from the endosperm of wheat grain. These components can be separated by alcohol fractionation or by using a non-alcoholic process (as disclosed in U.S. Pat. No. 5,610,277) employing the use of organic acids. Gliadin is soluble in 60-70% alcohol and comprises monomeric proteins with molecular weights ranging from 30,000 to 50,000 daltons. These proteins are classified as alpha-, beta-, gamma-, and omega-gliadins depending on their mobility during electrophoresis at low pH. Gliadin is primarily responsible for the elastic properties of wheat gluten. Glutenin is the alcohol insoluble fraction and contributes primarily to the elastic or rubbery properties of wheat gluten. Glutenin is a polymeric protein stabilized with inter-chain disulfide bonds and made up of high-molecular weight and low molecular weight subunits. Generally, glutenin exhibits a molecular weight exceeding one million daltons. Preferred fractionated wheat protein products comprise at least about 85% by weight protein, and more preferably at least about 90% by weight for gliadin and about 75% by weight protein, and more preferably at least about 80% by weight for glutenin, all proteins expressed on N×6.25, dry basis. Wheat gluten is commercially available, for example, from Meelunie BV, Amsterdam, Holland.

If a plurality of grain-based binders are added to the homogenous mixture of flour-based host/carrier and LMFS, it is preferred that the grain-based binders be added to the homogeneous mixture stepwise, starting with the grain-based binder having the lowest moisture content and then adding the grain-based binder having the next highest moisture content. Each grain-based binder should be fully mixed into the homogeneous mixture formed by the flour-based host/carrier and LMFS before adding the next grain-based binder.

Preferably, the wheat protein has a moisture content of about 7%, a protein content of about 80-85%, and a dietary fiber content of about 0.01-0.02%. Preferably, the wheat gluten has a moisture content of about 7%, a protein content of about 70-75%, and a dietary fiber of about 0.01-0.02%.

The amount of dietary fiber is measured by ICC Standard No. 156. The amount of crude protein is measured by ICC Standard No. 105/2.

The amount of grain-based binder added can vary based upon the nutritional profile and organoleptic characteristics desired in the all natural high fiber flour-based concentrate. A higher amount of wheat protein may be desired, for example, to impart a chewiness to a bread product.

In a preferred embodiment, the at least one grain-based binder includes wheat protein added in an amount of about 3 wt % to 12 wt % of the flour-based concentrate. In another preferred embodiment, the at least one grain-based binder includes wheat gluten added in an amount of about 3 wt % to 12 wt % of the flour-based concentrate.

In a preferred embodiment, the dry blending of the grain-based binder into the homogenous mixture further includes dry blending a grain-based texturizer into the homogeneous mixture. The grain-based texturizer is a grain-based product that provides a desired feel in the mouth when eating. For example, the grain-based texturizer can be starch derived from grain. In a preferred embodiment, the grain-based texturizer is wheat starch, more preferably modified wheat starch.

As used herein, the term “wheat starch” refers to a composition comprised of straight chain amylose and branched chain amylopectin isolated from wheat flour. Wheat starch is a byproduct when gluten, derived from wheat protein, is made. Wheat starch may be produced from wheat by various methods, all of which include crushing the plant material, washing the starch free from the protein, cellulose and other substances, further concentrating the starch composition, and subsequently drying and grinding the composition.

In a preferred embodiment, the wheat starch is a modified wheat starch. “Modified” means the wheat starch has been altered either chemically or physically. The modified wheat starch can also be another source of fiber. Modified wheat starch is commercially available. For example, modified wheat starch is described in U.S. Pat. No. 5,855,946 (incorporated herein by reference) and is sold under the name Fibersym® RW by MGP Ingredients, Inc., Atchison, Kans. The Fibersym® RW wheat starch has a low water-holding capacity which provides a smooth texture and has a neutral flavor.

Preferably, the grain-based texturizer has a moisture content greater than that of the LMFS. It is also preferred that the grain-based texturizer have a moisture content greater than that of grain-based binder. It is also preferred that the grain-based texturizer have a moisture content less than that of the flour-based host/carrier. Preferably, the wheat starch has a moisture content of about 10%, a protein content of about 0.05%, and a dietary fiber content of about 65-66%.

In another preferred embodiment, the grain-based texturizer includes wheat starch added in an amount of about 20 wt % to 50 wt %, more preferably about 30 wt % to about 40 wt %, of the flour-based concentrate. Wheat starch is particularly favorable for providing a softness to the comestible made with the high fiber flour-based concentrate of the invention.

In a preferred embodiment, the grain-based binder includes wheat protein or wheat gluten added in an amount of from about 3% to about 12% by weight of said flour-based concentrate, and the grain-based texturizer includes wheat starch added in an amount of from about 20% to about 50% by weight of said flour-based host/carrier.

In another aspect of the invention, a method for preparing an all natural high fiber flour-based comestible is provided. The method includes the formulation of a high fiber flour-based concentrate as described above. A liquid is then added to the flour-based concentrate to form a dough, and the dough is processed to form a high fiber flour-based comestible.

Processing can include any of the steps conventionally performed on a flour-based dough to form a comestible. For example, processing can include extruding, drying, baking, etc.

The comestible can be any comestible that has a flour base. Examples include, but are not limited to, bread, pizza dough, tortilla, cookies, cakes, pancakes, doughnuts, etc.

The present invention also includes in a preferred embodiment the step of subjecting the substantially dry flour-based concentrate resulting from the previous steps to a sifting process in order to regularize particle size of the dry flour-based concentrate. “Substantially dry” means that no liquid has been added to the ingredients of the concentrate during formation. The moisture present is from the endogenous moisture of the ingredients themselves.

The dry sifted flour-based concentrate will contain substantially uniform, i.e., “reguarlized” particles. “Sifting” means to pass the dry mixture through a sieve so as to break up and/or remove coarse or lumped particles from fine particles. For example, the sieve screen size can be from about 20 to about 45 U.S. mesh. Preferably, the sieve screen size is from about 30 to about 35 U.S. mesh.

The sifting process can be accomplished by, for example, moving the substantially dry mixture into a high speed sifter which will uniformly sift the entire flour-based concentrate utilizing an air flow system that extracts the finished sifted product by vacuum.

In a preferred embodiment, the sifted dry concentrate is withdrawn to an agglomerizer, such as a centrifuge air mixer, which will allow the particles to bind based on the binding power of the moisture exuded from the dry ingredients to provide particle aggregates of substantially uniform size and flow characteristics.

Furthermore, in a preferred embodiment, a flavor can be added during the sifting process. Such flavors include, but are not limited to, garlic, parsley, dehydrated dry flavors and/or texture enhancers such as rye, flax powder or any type of ingredient additive. These flavor/texture enhancers are added such that they will be sifted with the dry flour-based concentrate to ensure uniformity of size and blend with the resulting dry flour-based concentrate.

Additional ingredients can be added to the high fiber flour-based concentrate before being processed into a comestible. Such additional ingredients can include additional flour based ingredients. For example, if a high fiber bread is desired, bread flour having a higher protein content than conventional white flour can be added to the high fiber flour-based concentrate to form the high fiber bread. If a comestible, such as a cookie or cake is to be formed, a flour having a lower protein content than bread flour can be used.

A flour that has a high protein content and gluten strength, such as durum flour, is suitable for bread, but is less suitable for cakes, which are generally made from softer wheat flour, i.e., flour that has a lower protein content.

When forming the flour-based comestible, the high fiber flour-based concentrate is first mixed with a suitable flour. This mixing can include sifting. An amount of high fiber flour-based concentrate is added to the flour based upon the amount of fiber desired in the flour-based end product and the texture profile desired in the end product. More flour-based concentrate will be added if a higher amount of fiber is desired in the comestible. However, too much fiber can affect the desired texture of the product.

Ingredients may also be added that are non-flour based when forming the comestible. Examples of such additional ingredients include water, eggs, egg whites, yeast, baking soda, baking powder, flavorings, or any other edible material found in flour-based food products.

Without being bound by theory, it is believed that the high fiber flour-based concentrate acts as a reconstructed replacement for a portion of the normally derived flour used in flour-based products. By reconstructing the high fiber flour-based concentrate by utilizing different grain parts dry blended together, i.e., flour-based host/carrier, LMFS, grain-based binder, and grain-based texturizer, the high fiber flour-based concentrate is able to incorporate a higher amount of fiber than would be possible with conventional methods of adding fiber when formulating the comestible.

In another aspect of the invention, the dry flour-based concentrate can be loaded into a packaging system to form an article of manufacture suitable for an end consumer.

### EXAMPLES

Provided herein are examples of products which can be made using the present invention. They include a high fiber flour-based concentrate which can be prepared and sold as an article of commerce for subsequent use in, e.g., bakery goods, including, but not limited to bread, pastry products, pizza dough, etc. The invention is not to be limited, however, to the examples set forth herein.

### Example 1

In this example, a high fiber flour-based concentrate was prepared in accordance with the invention. The high fiber flour-based concentrate was manufactured using stone ground whole wheat as the flour-based host/carrier. Vegetable fiber in the form of Jerusalem artichoke was used as the low-moisture content fiber source (LMFS). Wheat protein was added as a flour-based binder having a moisture content greater than that of the LMFS. Modified wheat starch was added as a texturizer and an additional fiber source.

The high fiber flour-based concentrate was formed by placing 50 lbs of stone ground whole wheat (Bemis Co., Inc., Crossett, Ark.) in a ribbon mixer container (Charles Ross & Sons, Hauppauge, N.Y.) having a 150 lb. capacity. The whole wheat had a moisture content of 11.5% and a dietary fiber content of 0.5-0.7%. 7.5 lbs of vegetable fiber in the form of inulin derived from Jerusalem artichoke (Meelunie American Inc., Farmington Hills, Mich.) were then added to the mixer. The vegetable fiber had a moisture content of about 5.0% and a dietary fiber content of 85-90%.

The ribbon mixer was run from 4-6 minutes at 17.5 rpm to blend the vegetable fiber and whole wheat based host/carrier. 10 lbs of wheat protein (MGP Ingredients, Inc., Atchison, Kans.) was then added to the mixer. The wheat protein had a moisture content of about 7.0% and a dietary fiber content of 0.01-0.02%. The ingredients were then mixed for an additional 4-6 minutes until fully blended. 45 lbs. of modified wheat starch (Fibersym® RW, MGP Ingredients, Inc.) was then added. The modified wheat starch had a moisture content of about 10% and a dietary fiber content of 65-66%. The ingredients were then blended for approximately 30 minutes until all ingredients were uniformly blended without coagulation of the product.

Mixing times can vary based on the humidity conditions and the amount of blend that is being prepared.

The high fiber flour-based concentrate was then auguered into a high speed sifter that uniformly sifted the entire high fiber flour-based concentrate utilizing of an air flow system that extracts the finished sifted product into a centrifuge air mixer. This permits the particles to bind and properly blend to provide uniformity. The finished product was bagged into 50 lb bags using the air flow system.

The nutritional analysis of the high fiber flour-based concentrate is set forth below for a serving size of 100 grams:

| | | ANALYTICAL | ANALYTICAL | ROUNDED | % |
|---|---|---|---|---|---|
| LABEL | | DATA PER | DATA PER | DATA PER | DAILY |
| ANALYTES | | 100 g | SERVING | SERVING | VALUE |
| Calories | | 359.7 | 359.7 | 360 | |
| Calories from Fat | | 13.6 | 13.6 | 15 | |
| Total Fat | (g) | 1.51 | 1.51 | 1.5 | 2 |
| Saturated Fat | (g) | 0.33 | 0.33 | 0 | 0 |
| Trans Fat | (g) | <0.10 | <0.10 | 0 | |
| Cholesterol | (mg) | <1.0 | <1.0 | 0 | 0 |
| Sodium | (mg) | 212 | 212 | 210 | 9 |
| Total | (g) | 71.9 | 71.9 | 72 | 24 |
| Carbohydrate | | | | | |
| Dietary Fiber | (g) | 35.50 | 35.50 | 36 | 144 |
| Sugars | (g) | 2.33 | 2.33 | 2 | |
| Protein (F-6.25) | (g) | 14.63 | 14.63 | 15 | |
| Vitamin A | (IU) | <5 | <5 | | * |
| Vitamin C | (mg) | N/A | N/A | | N/A |
| Calcium | (mg) | 31.7 | 31.7 | | 4 |
| Iron | (mg) | 2.1 | 2.1 | | 10 |
| CONTRIBUTING | | | | | |
| ANALYTES | | | | | |

| | | | |
|---|---|---|---|
| Moisture | (g) | 10.34 | 10.34 |
| Ash | (g) | 1.58 | 1.58 |
| Beta Carotene | (IU) | <5 | <5 |
| Retinol | (IU) | <5 | <5 |
| Vit A % Beta | | * | |
| Carotene | | | |

* Contains Less than 2% of the Daily Value of this nutrient.

As can be seen from the results above, the 100 gram serving of high fiber flour-based concentrate includes 144% of the daily value of dietary fiber.

### Example 2

The all natural high fiber flour-based concentrate from Example 1 was used to make a bread high in dietary fiber. One part (approximately 38 grams) of the all natural high fiber flour-based concentrate and three parts (approx. 114 grams) bread flour (King Arthur® bread flour, Norwich, Vt.) were sifted together to form a fiber enriched bread flour.

The high fiber flour-based concentrate had a dietary fiber content of 36 grams per 100 grams of flour-based concentrate. The bread flour had a dietary fiber content of 4.7 grams per 100 grams of bread flour.

5 cups of water and 1 oz. yeast was added to the fiber enriched bread flour. The resulting dough was kneaded until the dough formed an elastic texture. The dough was permitted to rise at room temperature (approx 75° F.) for 1.5 hrs. The dough was then formed into loaves and permitted to rise for an additional 30 min. The dough was then baked in an oven for 20 min. at 375° F.

The resulting bread has a dietary fiber content of approximately 8-12 grams per 100 gram serving. The bread had a natural lightness and good mouth feel, without the traditional heaviness of high fiber breads.

Thus, while there have been described above what are presently believed to be the preferred embodiments of the invention, those skilled in the art will understand that other and further embodiments may be made in accordance with the true spirit of the invention and it is intended to include such other embodiments as fall within the scope of the invention as pointed out in the appended claims.

What is claimed is:

1. A method of preparing an all natural high fiber flour-based concentrate comprising:
a) dry functionalizing a flour-based host/carrier to exude endogenous moisture,
b) semi-sequentially dry combining (SSDC) a low-moisture-content fiber source (LMFS) with said flour-based host/carrier in an amount which provides a substantially homogenous mixture throughout said flour-based host/carrier, and
c) dry blending at least one grain-based binder into said homogeneous mixture to form a substantially dry high fiber flour-based concentrate, said grain-based binder having a moisture content greater than that of said LMFS.

2. A method according to claim 1 further comprising:
d) subjecting the substantially dry high fiber flour-based concentrate resulting from steps a) through c) to sifting to regularize particles size of said concentrate.

3. A method according to claim 2 further comprising:
e) agglomerizing said sifted concentrate resulting from step d) to provide particle aggregates of substantially uniform size and flow characteristics.

4. A method according to claim 2 further comprising adding flavors to said flour-based concentrate during said sifting step.

5. A method according to claim 1, wherein said dry blending step further comprises dry blending a grain-based texturizer having a moisture content greater than that of said LMFS.

6. A method according to claim 5, wherein the moisture content of said grain-based texturizer is greater than that of said grain-based binder.

7. A method according to claim 6, wherein the moisture content of said grain-based texturizer is less than that of said flour-based host/carrier.

8. A method according to claim 5, wherein said grain-based texturizer comprises wheat starch added in an amount of from about 20% to about 50% by weight of said flour-based concentrate.

9. A method according to claim 1, wherein said flour-based host/carrier is a wheat-based flour having a moisture content of from about 10% to about 16%.

10. A method according to claim 9, wherein said wheat-based flour is durum wheat flour having a moisture content of from about 12% to about 15%.

11. A method according to claim 9, wherein said wheat-based flour is whole wheat flour having moisture content of from about 10% to about 13%.

12. A method according to claim 1, wherein said LMFS is a vegetable fiber having a moisture content of less than about 6% and a dietary fiber content of greater than about 80%.

13. A method according to claim 12, wherein said vegetable fiber has a moisture content of about 5% and a dietary fiber content of at least about 85%.

14. A method according to claim 1, wherein said LMFS is a vegetable fiber comprising inulin.

15. A method according to claim 14, wherein said vegetable fiber is derived from Jerusalem artichoke.

16. A method according to claim 1, wherein said LMFS is added in an amount of from about 4 wt % to about 16 wt % of said flour-based concentrate.

17. A method according to claim 16, wherein said LMFS is inulin derived from Jerusalem artichoke in an amount of about 7.5 wt % of said flour-based concentrate.

18. A method according to claim 1, wherein said at least one grain-based binder is selected from the group consisting of wheat protein, wheat gluten, and a combination thereof.

19. A method according to claim 18, wherein said at least one grain-based binder comprises wheat protein added in an amount of from about 3 wt % to about 12 wt % of said flour-based concentrate.

20. A method according to claim 18, wherein said at least one grain-based binder comprises wheat gluten added in an amount of from about 3 wt % to about 12 wt % of said flour-based concentrate.

21. A method according to claim 5, wherein said at least one grain-based binder comprises wheat protein or wheat gluten added in an amount of from about 3% to about 12% by weight of said flour-based concentrate, and said grain-based texturizer comprises wheat starch added in an amount of from about 20% to about 50% by weight of said flour-based concentrate.

22. A method according to claim 1, wherein said at least one grain-based binder is a plurality of grain-based binders having a particular moisture content, and wherein said grain-based binders are added in an order of increasing moisture content.

23. A method of preparing an all natural high fiber flour-based comestible comprising:
a) dry functionalizing a flour-based host/carrier to extract endogenous moisture,
b) semi-sequentially dry combining (SSDC) a low-moisture-content fiber source (LMFS) with said flour-based host/carrier in an amount which provides a substantially homogenous mixture throughout said flour-based host/carrier,
c) dry blending at least one grain-based binder into said homogeneous mixture to form a substantially dry high fiber flour-based concentrate, said grain-based binder having a moisture content greater than that of said LMFS,
d) mixing the high fiber flour-based concentrate resulting from steps a) through c) with a suitable flour for a desired comestible and a liquid to form a dough, and
e) processing said dough to form said desired comestible.

24. A method according to claim 23, wherein said dry blending step further comprises dry blending a grain-based texturizer having a moisture content greater than that of said LMFS.

25. A method according to claim 24, wherein said grain-based texturizer comprises wheat starch added in an amount of from about 20% to about 50% by weight of said flour-based concentrate.

26. A method according to claim 23, further comprising:
e) subjecting the substantially dry high fiber flour-based concentrate resulting from steps a) through c) to sifting to regularize particle size of said concentrate.

27. A method according to claim 20 further comprising:
e) agglomerizing said sifted dry concentrate resulting from step d) to provide particle aggregates of substantially uniform size and flow characteristics.

28. A method according to claim 20 further comprising adding flavors to said flour-based concentrate during said sifting step.

29. An article of manufacture comprising all natural high fiber flour-based concentrate, said flour-based concentrate manufactured by the steps of:
a) dry functionalizing a flour-based host/carrier to exude endogenous moisture,
b) semi-sequentially dry combining (SSDC) a low-moisture-content fiber source (LMFS) with said flour-based host/carrier in an amount which provides a substantially homogenous mixture throughout said flour-based host/carrier, and
c) dry blending at least one grain-based binder into said homogeneous mixture to form a substantially dry high fiber flour-based concentrate, said grain-based binder having a moisture content greater than that of said LMFS.

30. An article of manufacture according to claim 29, further comprising:
d) subjecting the substantially dry high fiber flour-based concentrate resulting from steps a) through c) to sifting to regularize particles size of said dry mixture.

31. An article of manufacture according to claim 30, further comprising:
e) agglomerizing said sifted concentrate resulting from step d) based on a binding characteristic of said moisture exudate of said dry ingredients to provide particle aggregates of substantially uniform size and flow characteristics.

32. An article of manufacture according to claim 30, further comprising adding flavors to said dry mixture flour-based concentrate during said sifting step.

33. A comestible comprising an all natural high fiber flour-based concentrate, said flour-based concentrate manufactured by the steps of:
a) dry functionalizing a flour-based host/carrier to extract endogenous moisture,
b) semi-sequentially dry combining (SSDC) a low-moisture-content fiber source (LMFS) with said flour-based host/carrier in an amount which provides a substantially homogenous mixture throughout said flour-based host/carrier, and
c) dry blending at least one grain-based binder into said homogeneous mixture to form a substantially dry high fiber flour-based concentrate, said grain-based binder having a moisture content greater than that of said LMFS.

34. A comestible comprising:
a) a flour-based host/carrier, wherein said flour-based host/carrier has been functionalized to exude endogenous moisture,
b) a low-moisture-content fiber source (LMFS) that has been semi-sequentially dry combined (SSDC) with said flour-based host/carrier in an amount which provides a substantially homogenous mixture throughout said flour-based host/carrier, and
c) at least one grain-based binder that has been dry blended into said homogeneous mixture, said grain-based binder having a moisture content greater than that of said LMFS.
